(19) United States
(12) Patent Application Publication
(10) Pub. No.: US 2012/0216711 A1
(43) Pub. Date: Aug. 30, 2012

(54) COATING COMPOSITION COMPRISING TUNGSTEN TREATED TITANIUM DIOXIDE HAVING IMPROVED PHOTOSTABILITY

(75) Inventors: John Davis Bolt, Kingston, TN (US); Eugene Michael McCarron, III, Chadds Ford, PA (US); Charles David Musick, Waverly, TN (US)

(73) Assignee: E.I. DU PONT DE NEMOURS AND COMPANY, WILMINGTON, DE (US)

(21) Appl. No.: 13/505,482

(22) PCT Filed: Nov. 9, 2010
(86) PCT No.: PCT/US10/55896

§ 371 Date: May 2, 2012

Related U.S. Application Data
(60) Provisional application No. 61/384,884, filed on Sep. 21, 2010.

(51) Int. Cl. C09D 1/00; C08K 3/28

(52) U.S. Cl. 106/286.4; 524/406

(57) ABSTRACT

This disclosure relates to a coating composition comprising an inorganic particle, wherein the inorganic particle comprises at least about 0.002% of tungsten, based on the total weight of the inorganic particle, and has a photostability ratio (PSR) of at least about 2, as measured by the Ag⁺ photoreduction rate, and color as depicted by an L* of at least about 97.0, and b* of less than about 4. The disclosure also relates to dried films prepared from these coating compositions.

### BACKGROUND OF THE DISCLOSURE

1. Field of the Disclosure

The present disclosure relates to a coating composition comprising titanium dioxide, and in particular to a coating composition comprising tungsten treated titanium dioxide.

2. Background of the Disclosure

Coating compositions may be solvent based such as alkyd coatings, urethane coatings or unsaturated polyester coatings or water based such as water soluble or dispersible compositions such as latex compositions. Solvent based coatings typically comprise a dispersant for the pigment or binder and a solvent. Water based coatings comprise a dispersant for the pigment, or a binder and water or a mixture of water and a water-miscible solvent. Additives may be present to improve properties of the coating composition. Alkyd coating is a conventional liquid coating based on alkyd resins, typically a paint, clear coating, or stain. The alkyd resins are complex branched and cross-linked polyesters containing unsaturated aliphatic acid residues. Another type of coating is a urethane coating which is a conventional liquid coating based on Type I urethane resins, typically a paint, clear coating, or stain. Urethane coatings typically contain the reaction product of a polyisocyanate, usually toluene diisocyanate, and a polyhydric alcohol ester of drying oil acids. Unsaturated polyester coating is a conventional liquid coating based on unsaturated polyester resins, dissolved in monomers and containing initiators and catalysts as needed, typically as a paint, clear coating, or gel coat formulation.

Water-dispersible coating compositions are surface coatings intended for the decoration or protection of a substrate, comprising essentially an emulsion, latex, or suspension of a film-forming material dispersed in an aqueous phase, and optionally containing surfactants, protective colloids and thickeners, pigments and extender pigments, preservatives, fungicides, freeze-thaw stabilizers, antifoam agents, agents to control pH, coalescing aids, and other ingredients. Water-dispersed coating compositions are exemplified by, but not limited to, pigmented coatings such as latex paints, unpigmented coatings such as wood sealers, stains, and finishes, coating compositions for masonry and cement, and water-based asphalt emulsions. For latex paints the film forming material is a latex polymer of acrylate acrylic, vinyl-acrylic, vinyl, or a mixture thereof. Such water-dispersed coating compositions are described by C. R. Martens in “Emulsion and Water-Soluble Paints and Coatings” (Reinhold Publishing Corporation, New York N.Y., 1965). Water based coatings such as latex coatings are described in U.S. Pat. No. 6,881,782 issued Apr. 19, 2005.

Titanium dioxide pigments are prepared using either the chloride process or the sulfate process. In the preparation of titanium dioxide pigments by the vapor phase chloride process, titanium tetrachloride, TiCl₄, is reacted with an oxygen containing gas at temperatures ranging from about 900° C. to about 1600° C., the resulting hot gaseous suspension of TiO₂ particles and free chlorine is discharged from the reactor and must be quickly cooled below about 600° C., for example, by passing it through a conduit, i.e., flue, where growth of the titanium dioxide pigment particles and agglomeration of said particles takes place.

It is known to add various substances, such as silicon compounds and aluminum compounds, to the reactants in order to improve the pigmentary properties of the final product. Aluminum trichloride added during the process has been found to increase rutile in the final product, and silicon tetrachloride that becomes silica in the final product has been found to improve carbon black undertone (CBU), particle size and pigment abrasion. It is useful to be able to add elements to the titanium dioxide particles. However, the process and materials to be added to improve properties of the titanium dioxide particles may be hazardous.

One method of adding elements to the surface of a particle is by impregnation with a solution containing the element. This is difficult to do with pyrogenically prepared metal oxide particles since the properties of the pyrogenically produced metal oxides change upon contact with a liquid medium.

A need exists for a low cost approach for preparing coating compositions comprising pyrogenically prepared metal oxide particles, particularly titanium dioxide particles, comprising elements such as tungsten that provide improved photostability without changing the color of the product.

### SUMMARY OF THE DISCLOSURE

In a first aspect, the disclosure provides a coating composition comprising inorganic particles, typically inorganic metal oxide or mixed metal oxide particles, more typically titanium dioxide (TiO₂) particles, comprising at least about 0.002% of tungsten, more typically at least about 0.004% of tungsten, and still more typically at least about 0.01% of tungsten, and most typically at least about 0.05% of tungsten, based on the total weight of the inorganic particles, wherein the inorganic particles, have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the inorganic particles, more typically inorganic metal oxide or mixed metal oxide particles, and most typically titanium dioxide particles, comprising tungsten may further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the inorganic particles.

In a second aspect, the disclosure provides a dry film prepared from a coating composition comprising inorganic particles, typically inorganic metal oxide or mixed metal oxide particles, more typically titanium dioxide (TiO₂) particles, comprising at least about 0.002% of tungsten, more typically at least about 0.004% of tungsten, and still more typically at least about 0.01% of tungsten, and most typically at least about 0.05% of tungsten, based on the total weight of the inorganic particles, wherein the inorganic particles, have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the inorganic particles, more typically inorganic metal oxide or mixed metal oxide particles, and most typically titanium dioxide particles, comprising tungsten may further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the inorganic particles.

### BRIEF DESCRIPTION OF THE DRAWING

FIG. 1 is a schematic illustration showing the process for preparing titanium dioxide (TiO₂).

### DETAILED DESCRIPTION OF THE DISCLOSURE

This disclosure relates to a coating composition comprising inorganic particles, typically inorganic metal oxide or mixed metal oxide particles, more typically titanium dioxide (TiO₂) particles, comprising at least about 0.002% of tungsten, more typically at least about 0.004% of tungsten, and still more typically at least about 0.01% of tungsten, and most typically at least about 0.05% of tungsten, based on the total weight of the inorganic particles. These inorganic particles have a photostability ratio (PSR) of at least about 2, more typically at least about 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the inorganic particles, more typically inorganic metal oxide or mixed metal oxide particles, and most typically titanium dioxide particles, comprising tungsten may further comprise alumina in the amount of about 0.06% to about 5% of alumina, more typically about 0.2% to about 4% of alumina, still more typically about 0.5% to about 3% of alumina, and most typically about 0.8% to about 2%, based on the total weight of the inorganic particles, and a dry film or paint made therefrom.

### Coating Composition:

Coating compositions useful in this disclosure may be solvent based such as alkyd coatings, urethane coatings or unsaturated polyester coatings or water based such as water soluble or dispersible compositions such as latex compositions. Solvent based coatings typically comprise a dispersant for the pigment or binder and a solvent. Water based coatings comprise a dispersant for the pigment, or a binder and water or a mixture of water and a water-miscible solvent. Additives may be present to improve properties of the coating composition.

By the term “alkyd coating”, as used hereinafter, is meant a conventional liquid coating based on alkyd resins, typically a paint, dear coating, or stain. The alkyd resins are complex branched and cross-linked polyesters containing unsaturated aliphatic acid residues.

By the term “urethane coating”, as used hereinafter, is meant a conventional liquid coating based on Type urethane resins, typically a paint, dear coating, or stain. Urethane coatings typically contain the reaction product of a polyisocyanate, usually toluene diisocyanate, and a polyhydric alcohol ester of drying oil acids.

By the term “unsaturated polyester coating”, as used hereinafter, is meant a conventional liquid coating based on unsaturated polyester resins, dissolved in monomers and containing initiators and catalysts as needed, typically as a paint, dear coating, or gel coat formulation.

By the term “water-dispersible coating compositions” as used herein is meant surface coatings intended for the decoration or protection of a substrate, comprising essentially an emulsion, latex, or suspension of a film-forming material dispersed in an aqueous phase, and optionally containing surfactants, protective colloids and thickeners, pigments and extender pigments, preservatives, fungicides, freeze-thaw stabilizers, antifoam agents, agents to control pH, coalescing aids, and other ingredients. Water-dispersed coating compositions are exemplified by, but not limited to, pigmented coatings such as latex paints, unpigmented coatings such as wood sealers, stains, and finishes, coating compositions for masonry and cement, and water-based asphalt emulsions. For latex paints the film forming material is a latex polymer of acrylate acrylic, vinyl-acrylic, vinyl, or a mixture thereof. Such water-dispersed coating compositions are described by C. R. Martens in “Emulsion and Water-Soluble Paints and Coatings” (Reinhold Publishing Corporation, New York N.Y., 1965). Water based coatings such as latex coatings are described in U.S. Pat. No. 6,881,782 issued Apr. 19, 2005.

The inorganic particle is present in the amount of about 15 to about 30%, more typically about 20 to about 28%, and still more typically about 20 to about 25%, based on the total weight of the coating composition. Solvents are used to prepare the paint composition. Coating compositions are prepared by methods that are well known to those skilled in the art. Additives may be present to improve properties of the coating composition such as, for example, a plasticizer, antifoam agent, pigment extender, pH adjuster, tinting color and biocide. Such typical ingredients are listed for example in Technology of Paints, Varnishes and Lacquers, edited by C. R. Martens, R. E. Kreiger Publishing Co., p. 515 (1974). Functional extenders such as barium sulfate, calcium carbonate, clay, gypsum, silica and talc may also be present.

### Treated Particle:

R is contemplated that any inorganic particle, and in particular inorganic particles that are photoactive, will benefit from the treatment of this disclosure. By inorganic particle it is meant an inorganic particulate material that becomes dispersed throughout a final product such as a polymer melt or coating or laminate composition and imparts color and opacity to it. Some examples of inorganic particles include but are not limited to ZnO, ZnS, BaSO₄, CaCO₃, TiO₂, Lithopane, white lead, SrTiO₃, etc.

In particular, titanium dioxide is an especially useful particle in the processes and products of this disclosure. Titanium dioxide (TiO₂) particles useful in the present disclosure may be in the rutile or anatase crystalline form. They are commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference. The particle may be a pigment or nanoparticle.

By “pigment” it is meant that the titanium dioxide particles have an average size of less than 1 micron. Typically, the particles have an average size of from about 0.020 to about 0.95 microns, more typically, about 0.050 to about 0.75 microns and most typically about 0.075 to about 0.50 microns. By “nanoparticle” it is meant that the primary titanium dioxide particles typically have an average particle size diameter of less than about 100 nanometers (nm) as determined by dynamic light scattering that measures the particle size distribution of particles in liquid suspension. The particles are typically agglomerates that may range from about 3 nm to about 6000 nm.

The titanium dioxide particle can be substantially pure titanium dioxide or can contain other metal oxides, such as alumina. Other metal oxides may become incorporated into the particles, for example, by co-oxidizing, post-oxidizing or co-precipitating titanium compounds with other metal compounds or precipitating other metal compounds on to the surface of the titanium dioxide particles. These are typically hydrous metal oxides. If co-oxidized, post-oxidized, precipitated or co-precipitated the amount of the metal oxide is about 0.06 to about 5%, more typically about 0.2% to about 4%, still more typically about 0.5% to about 3%, and most typically about 0.8% to about 2%, based on the total weight of the titanium dioxide particles. Tungsten may also be introduced into the particle using co-oxidizing, or post-oxidizing. If co-oxidized or post-oxidized at least about 0.002 wt. % of the tungsten, more typically, at least about 0.004 wt. %, still more typically at least about 0.01 wt. % tungsten, and most typically at least about 0.05 wt. % may be present, based on the total particle weight.

### Process for Preparing Treated Titanium Dioxide Particles

The process for producing titanium dioxide particle comprises:
a) mixing of chlorides of, titanium, tungsten or mixtures thereof; wherein at least one of the chlorides is in the vapor phase;
(b) oxidizing the chlorides of, titanium, tungsten or mixtures thereof; and
(c) forming titanium dioxide (TiO₂) particles comprising at least about 0.002% of tungsten, more typically at least about 0.004% of tungsten and still more typically at least about 0.01% of tungsten, and most typically at least about 0.05% of tungsten, based on the total weight of the titanium dioxide particles. These titanium dioxide particles have a photostability ratio (PSR) of at least 2, more typically at least 4, and still more typically at least 10, as measured by the Ag⁺ photoreduction rate, and color as depicted by an L* of at least about 97.0, more typically at least about 98, and most typically at least about 99.0, and b* of less than about 4, and more typically less than about 3. Typically the titanium dioxide particles comprising tungsten further comprise alumina in the amount of about 0.06 to about 5% of alumina, more typically about 0.2% to about 4% of alumina, still more typically about 0.5% to about 3% of alumina, and most typically about 0.8% to about 2%, based on the total weight of the titanium dioxide particles.

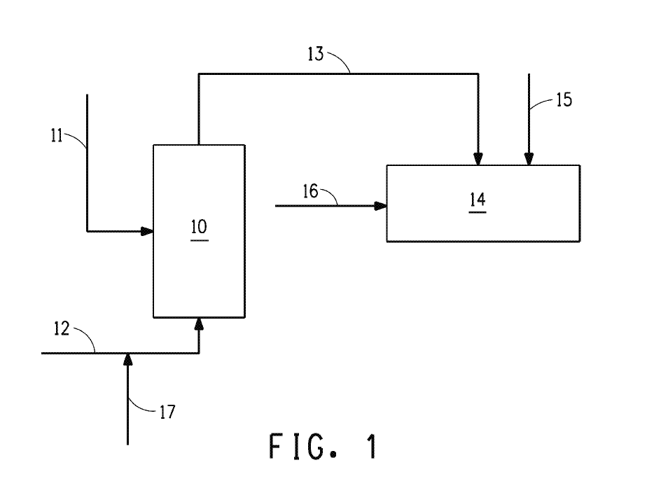

Methods known to one skilled in the art may be used to add tungsten to the titanium dioxide particles. In one specific embodiment, tungsten may be added to the titanium dioxide particle from an alloy comprising tungsten. As shown in FIG. 1, the alloy 11 and chlorine 12 are added to the generator 10. This reaction can occur in fluidized beds, spouting beds, packed beds, or plug flow reactors. The inert generator bed may comprise materials such as silica sand, glass beads, ceramic beads, TiO₂ particles, or other inert mineral sands. The alloy comprising aluminum, titanium or mixtures thereof and tungsten, 11, reacts in the generator 10 according to the following equations:

2Al+3Cl₂→2AlCl₃+heat

Ti+2Cl₂→TiCl₄+heat

W+3Cl₂→WCl₅+heat

Al₁₂W+21Cl₂→12AlCl₃+WCl₆+heat

The heat of reaction from the chlorination of the aluminum or titanium metal helps provide sufficient heat to drive the kinetics of the reaction between chlorine and one or more of the other elements.

Titanium tetrachloride 17 may be present during this reaction to absorb the heat of reaction. The chlorides formed in-situ comprise chlorides of the tungsten and chlorides of aluminum such as aluminum trichloride, chlorides of titanium such as titanium tetrachloride or mixtures thereof. The temperature of the reaction of chlorine with the alloy should be below the melting point of the alloy but sufficiently high enough for the rate of reaction with chlorine to provide the required amount of chlorides to be mixed with the TiCl₄.

Typical amounts of chlorine used in step (a) are about 0.4% to about 20%, more typically about 2% to about 5%, by weight, based on the total amount of all reactants. Typical amounts of titanium tetrachloride are about 75% to about 99,5% added in step (a) and (b), and more typically about 93% to about 98%, by weight, based on the total amount of all reactants.

The reaction of chlorine with the alloy occurs at temperature of above 190° C., more typically at temperature of about 250° C. to about 650° C., and most typically at temperatures of about 300° C. to about 500° C. In one specific embodiment where the metal is Ti the reaction occurs at temperature of above 50° C. (bp of TiCl₄=136° C.), more typically at temperature of about 200° C. to about 1000° C., and most typically at temperatures of about 300° C. to about 500° C.

The chlorides, 13, formed in the in-situ step flow into an oxidation reactor 14 and titanium tetrachloride 15 is then added to the chlorides, such that titanium tetrachloride is present in a major amount. Vapor phase oxidation of the chlorides from step (a) and titanium tetrachloride is by a process similar to that disclosed, for example, in U.S. Pat. Nos. 2,488,439, 2,488,440, 2,559,638, 2,833,627, 3,208,866, 3,505,091, and 7,476,378. The reaction may occur in the presence of neucleating salts such as potassium chloride, rubidium chloride, or cesium chloride.

Such reaction usually takes place in a pipe or conduit, wherein oxygen 16, titanium tetrachloride 15 and the in-situ formed chlorides comprising chlorides of tungsten and chlorides of aluminum such as aluminum trichloride, chlorides of titanium such as titanium tetrachloride or mixtures thereof 13 are introduced at a suitable temperature and pressure for production of the treated titanium dioxide. In such a reaction, a flame is generally produced.

Downstream from the flame, the treated titanium dioxide produced is fed through an additional length of conduit wherein cooling takes place. For the purposes herein, such conduit will be referred to as the flue. The flue should be as long as necessary to accomplish the desired cooling. Typically, the flue is water cooled and can be about 50 feet (15.24 m) to about 3000 feet (914.4 m), typically about 100 feet (30.48 m) to about 1500 feet (457.2 m), and most typically about 200 feet (60.96 m) to 1200 feet (365.76 m) long.

The following Examples illustrate the present disclosure. All parts, percentages and proportions are by weight unless otherwise indicated,

### EXAMPLES

Photostability ratio (PSR) is the rate of photoreduction of Ag+ by TiO₂ particles without tungsten (control samples) divided by the rate of photoreduction of Ag+ by the otherwise same TiO₂ particles comprising tungsten. The rate of photoreduction of Ag+ can be determined by various methods. A convenient method was to suspend the TiO₂ particles in 0.1 M AgNO₃ aqueous solution at a fixed ratio of TiO₂ to solution, typically 1:1 by weight. The suspended particles were exposed to UV light at about 0.2 mW./cm² intensity. The reflectance of visible light by the suspension of TiO₂ particles was monitored versus time. The reflectance decreased from the initial value to smaller values as silver metal was formed by the photoreduction reaction, Ag⁺−>Ag^{o}. The rate of reflectance decrease versus time was measured from the initial reflectance (100% visible reflectance with no UV light exposure) to a reflectance of 90% after UV exposure; that rate was defined as the rate of Ag⁺ photoreduction.

Color as measured on the CIE 1976 color scale, L, a*, and b*, was measured on pressed pellets of dry TiO₂ powder.

### Comparative Example 1

Titanium dioxide made by the chloride process comprising 1.23% alumina by weight and having an L*a*b* color index of (99.98, 0,60, 2.13) and a rate of Ag⁺ photoreduction of 0.0528 sec⁻¹ was fired under flowing oxygen at 4° C./min to 1000° C. and held at temperature for 3 hours; furnace cooled to 750° C. and held at temperature for 1 hour; furnace cooled to 500° C. and held at temperature for 3 hours; furnace cooled to 250° C. and held at temperature for 3 hours; and finally furnace cooled to room temperature. After firing the sample had an L*a*b* color index of (99,15, −0.45, 2.17) and a rate of Ag⁺ photoreduction of 0.1993 sec⁻¹.

### Comparative Example 2

Titanium dioxide made by the chloride process comprising 0.06% alumina by weight and having an L*a*b* color index of (99.43, −0.58, 1.36) and a photoractivity rate of 0.3322 was fired under flowing oxygen at 4° C./min to 1000° C. and held at temperature for 3 hours; furnace cooled to 750° C. and held at temperature for 1 hour; furnace cooled to 500° C. and held at temperature for 3 hours; furnace cooled to 250° C. and held at temperature for 3 hours; and finally furnace cooled to room temperature. After firing the sample had an L*a*b* color index of (97.71, −0.03, 1.89) and a photoactivity rate of 0.2229 sec⁻¹.

### Example 3

Titanium dioxide similar to that described in Comparative Example 1 was well mixed with various amounts of ammonium tungstate, (NH₄)₁₀W₁₂O₄₁·5H₂O, to give samples having the W contents listed below. These samples were fired as described in Comparative Example 1. After firing the samples had L*a*b* color and photostability ratios (PSR) as given in the following table:

| W (wt. %) | L* | a* | b* | PSR |
|---|---|---|---|---|
| 0.0 | 99.15 | −0.45 | 2.17 | 1.0 |
| 0.34 | 99.00 | −0.71 | 2.72 | 3.0 |
| 1.72 | 98.56 | −0.82 | 3.17 | 10.4 |
| 3.44 | 98.41 | −0.90 | 3.11 | 211.4 |

The increased incorporation of W clearly enhanced photostability up to roughly a factor of 200 while the color was only minimally affected.

### Example 4

Titanium dioxide similar to that described in Comparative Example 1 was impregnated via incipient wetness with various amounts of ammonium tungstate, (NH₄)₁₀W₁₂O₄₁·5H₂O, to give samples having the W contents listed below. These samples were fired as described in Comparative Example 1. After firing the samples had L*a*b* color and photostability ratios as given in the following table:

| W (wt. %) | L* | a* | b* | PSR |
|---|---|---|---|---|
| 0.0 | 98.16 | 0.02 | 2.09 | 1.0 |
| 0.34 | 97.97 | −0.02 | 2.53 | 2.2 |
| 1.72 | 97.52 | −0.15 | 2.79 | 10.0 |
| 3.44 | 97.41 | −0.53 | 3.34 | 67.4 |

The increased incorporation of W clearly enhanced photostability up to roughly a factor of 67 while the color index was only minimally affected.

### Example 5

Titanium dioxide similar to that described in Comparative Example 2 was well mixed with amounts of ammonium tungstate, (NH₄)₁₀W₁₂O₄₁·5H₂O, to give samples having the W contents listed below. These samples were fired as described in Comparative Example 1. After firing the samples had L*a*b* color and photostability ratios as given in the following table:

| W (wt. %) | W | L* | a* | b* | PSR |
|---|---|---|---|---|---|
| 0.0 | 0.0 | 97.71 | −0.03 | 1.89 | 1.0 |
| 0.34 | 1x | 97.73 | −0.21 | 2.19 | 4.3 |
| 1.72 | 5x | 97.18 | −0.56 | 1.94 | 139.0 |
| 3.44 | 10x | 97.03 | −0.83 | 2.45 | 113.8 |

The increased incorporation of W clearly enhanced photostability up to roughly a factor of 140 while the color index was only minimally affected.

### Comparative Example 6

Titanium dioxide similar to that described in Comparative Example 1 was well mixed with various amounts of ammonium molybdate, (NH₄)₆Mo₇O₂₄·4H₂O, to give samples having the Mo contents listed below. These samples were fired as described in Comparative Example 1. After firing the samples had L*a*b* color and photostability ratios as given in the following table:

| Mo (wt. %) | L* | a* | b* | PSR |
|---|---|---|---|---|
| 0.0 | 98.76 | −0.37 | 2.48 | 1 |
| 0.18 | 94.08 | −3.45 | 17.96 | 314.8 |
| 0.91 | 93.77 | −4.47 | 30.45 | no rate |
| 1.83 | 91.89 | −5.27 | 35.82 | no rate |

The increased incorporation of Mo clearly enhanced photostability to the point where, at the higher Mo concentrations, the photostability ratio could not be determined. However, the material took on a decidedly yellow coloration clearly compromising its use as a white pigment,

### Comparative Example 7

Titanium dioxide similar to that described in Comparative Example 1 was impregnated via incipient wetness with various amounts of ammonium molybdate, (NH₄)₆Mo₇O₂₄·4H₂O, to give samples having Mo to

Al atomic ratios of 0.1, 0.5, and 1.0 versus 0.0 for the undoped control. These samples were fired as described in Comparative Example 1. After firing the samples had L*a*b* color and photostability ratios as given in the following table:

| Mo (wt. %) | L* | a* | b* | PSR |
|---|---|---|---|---|
| 0.0 | 97.79 | −0.19 | 2.57 | 1.0 |
| 0.18 | 92.62 | −3.61 | 24.15 | 862.3 |
| 0.91 | 92.66 | −4.21 | 31.63 | 1188.0 |
| 1.83 | 90.74 | −4.92 | 37.94 | no rate |

The incorporation of Mo clearly enhanced photostability to the point where, at the highest Mo concentration, the photostability ratio could not be determined. However, the material took on a decidedly yellow coloration clearly compromising its use as a white pigment.

### Example 8

525.0 g of water, 2.0 g of AMP-95 (2-amino-2-methly-1-propanol), available from Angus Chemical Company, Buffalo Grove, Ill., 6.0 g of Tamol® 1124 (a functionalized polyacrylic acid copolymer-50% active, M_{w}: about 2200), available from Rohm and Haas Company, Philadelphia, Pa. is added to a stainless steel pot. The contents of the pot are mixed using a Dispermat High-Speed Disperser fitted with a 50 mm diameter saw-tooth blade at 2000 rpm. 1000.0 grams each of the dry titanium dioxide samples having a W content as listed in Example 3 are added to form slurries/paints having a flat-grade-pigment solids concentration of approximately 65 wt %.

What is claimed is:

1. A coating composition comprising an inorganic particle, wherein the inorganic particle comprises at least about 0.002% of tungsten, based on the total weight of the inorganic particle, and has a photostability ratio (PSR) of at least about 2, as measured by the Ag⁺ photoreduction rate, and color as depicted by an L* of at least about 97.0, and b* of less than about 4.

2. The coating composition of claim 1 wherein the inorganic particle is an inorganic metal oxide or mixed metal oxide particle.

3. The coating composition of claim 2 wherein the inorganic metal oxide particle is titanium dioxide.

4. The coating composition of claim 3 further comprising a polymer.

5. The coating composition of claim 4 wherein the wherein the polymer is a high molecular weight melt processable polymer.

6. The coating composition of claim 5 wherein the high molecular weight melt processable polymer is in the form of a particle, granule, pellet or cube.

7. The coating composition of claim 3 wherein the amount of the titanium dioxide in the coating composition ranges from about 30 to about 90 wt %, based on the total weight of the coating composition.

8. The coating composition of claim 7 wherein the amount of the titanium dioxide in the coating composition ranges from about 50 to about 80 wt %, based on the total weight of the coating composition.

9. The coating composition of claim 3 wherein tungsten is present in the amount of at least about 0.004%, based on the total weight of the inorganic particle.

10. The coating composition of claim 3 wherein the photostability ratio (PSR) is at least about 4.

11. The coating composition of claim 3 wherein L* is at least about 98.

12. The coating composition of claim 3 wherein b* is less than about 3.

13. The coating composition of claim 3 wherein tungsten is added to the titanium dioxide particle by co-oxidation or post-oxidation.

14. The coating composition of claim 3 wherein wherein the tungsten is added to the titanium dioxide particle from an ahoy comprising tungsten.

15. The coating composition of claim 3 wherein the titanium dioxide particle further comprises alumina in the amount of about 0.06 to about 5% based on the total weight of the titanium dioxide particle.

16. A dried film prepared from a coating composition comprising an inorganic particle, wherein the inorganic particle comprises at least about 0.002% of tungsten, based on the total weight of the inorganic particle, and has a photostability ratio (PSR) of at least about 2, as measured by the Ag⁺ photoreduction rate, and color as depicted by an L* of at least about 97.0, and b* of less than about 4.

17. The dried film of claim 16 wherein the inorganic particle in the coating composition is an inorganic metal oxide or mixed metal oxide particle.

18. The dried film of claim 17 wherein the inorganic metal oxide particle is titanium dioxide.

19. The dried film of claim 18 wherein the titanium dioxide particle further comprises alumina in the amount of about 0.06 to about 5% based on the total weight of the titanium dioxide particle.
